(19) United States
(12) Patent Application Publication
(10) Pub. No.: US 2005/0252353 A1
(43) Pub. Date: Nov. 17, 2005

(54) Grip

(76) Inventors: Alfons Alber, Voran (IT); Gunther Thomas Kuhn, Meran (IT)

Correspondence Address: CHRISTIE, PARKER & HALE, LLP, PO BOX 7068, PASADENA, CA, 91109-7068, US

(21) Appl. No.: 11/127,683

(22) Filed: May 11, 2005

Related U.S. Application Data
(63) Continuation-in-part of application No. PCT/CH03/00572, filed on Aug. 25, 2003.

(30) Foreign Application Priority Data
Nov. 11, 2002 (CH) 1883/02

(51) Int. Cl. B25D 1/00; B23D 21/14

(52) U.S. Cl. 83/194

(57) ABSTRACT

According to an exemplary embodiment of the invention, a grip is provided for fastening different objects that can be attached to fingers, hands, arms or legs or other anatomical parts of a user. This grip prevents tools from slipping away or falling down. Objects do not need to be put away and a user, nevertheless, has a full freedom of movement in order to be able to perform different types of work such as cutting, tying, etc. more quickly than in the past. The grip may comprise a handle, a fixation element and a pulling element all of which being joint to one another in a fixed, gradual or continuous manner.

### CROSS-REFERENCE TO RELATED APPLICATION(S)

The present application is a continuation-in-part of International Application No. PCT/CH2003/000572, filed Aug. 25, 2003, which claims the benefit under 35 U.S.C. §119 of Switzerland Application No. 1883/02, filed Nov. 11, 2002, incorporated herein by reference in their entirety.

### FIELD OF THE INVENTION

The present invention relates to a grip and to a tool arrangement.

### TECHNOLOGICAL BACKGROUND

According to the prior art, when using shears (or scissors) and tools, these may fall out of the hand of a user. Furthermore, the holding of items of use may restrict the freedom of movement of the hands.

### SUMMARY OF THE INVENTION

There may be a need for a grip being convenient in use.

According to an exemplary embodiment of the invention, a grip is provided, comprising an angled handle, at least one fixing element, and a tool fastening portion. The at least one fixing element may be connected with a bottom part of the angled handle in such a manner that a distance between the angled handle and the at least one fixing element is adjustable to allow an object arranged between the angled handle and the at least one fixing element to be firmly engaged. The tool fastening portion may be arranged at an end portion of the angled handle and may be adapted to fasten at least one tool.

According to an exemplary embodiment of the invention, a tool arrangement is provided, comprising a grip having the above-mentioned features, and a tool which is fastenable at the tool fastening portion of the grip.

A modular grip/tool system may be provided according to an embodiment of the invention which may allow to flexibly adjust distances between a handle and a fixing element to given anatomical conditions of a user of the grip/tool combination. By taking this measure, the anatomical part of the user at which the grip shall be fastened can be clamped or otherwise be fixed between the fixing element and the angled handle so that it may be securely avoided that the grip/tool arrangement is undesirably lost (for instance falls down) while a user uses the tool/grip combination.

At the connection part or fastening portion of the grip, any desired tool may be fastened. In particular, a modular system may be provided which may allow to attach different compositions or tools to the grip. For instance, a composition in the form of a shear or a scissor may be added. Alternatively, for instance a spraying device may be attached to the tool connection element. Further alternatively, a measuring probe can be mounted on the tool fixing element.

According to an exemplary embodiment of the invention, a grip is provided for fastening different objects that shall be attached to fingers, hands, arms or legs or other anatomical parts of a user. This grip may prevent tools from slipping away or falling down. Items do not need to be put away and a user, nevertheless, may have a full freedom of movement in order to be able to perform different types of work such as cutting, tying, etc. quickly and accurately. The grip according to an embodiment of the invention may comprise a handle, a fixation element and a pulling or drawing element all of which may be joint to one another in a fixed, gradual or continuous manner.

According to an exemplary embodiment of the invention, different tools connected to a grip may be mounted on different body parts, like fingers, hands, arms or legs. By means of this mounting, the different items of use may be firmly held without restricting the freedom of movement of the hands, arms and legs of the user. The danger that different tools may fall out of the hand of a user may be prevented by means of this grip. From this grip, different tools may be created which may have additional operating levers.

Referring to the dependent claims, further exemplary embodiments of the invention will be described.

In the following, exemplary embodiments of the grip will be described. However, these embodiments also apply for the tool arrangement.

The tool fastening portion may be adapted to fasten at least one tool in a fixed or in a replaceable manner. In other words, it may be possible that a particular tool is attached and permanently fixed to the grip so as to have a directly usable tool which is prevented from falling out of a hand or another part of the body of a user at which it is fastened by means of the handle and the fixing element. Alternatively, the grip may be provided as some kind of construction set which allows to put any desired composition on the top of the tool fastening portion to realize different tool functionalities.

The tool fastening portion may be adapted to fasten a shear as the at least one tool. Such a shear or scissor may be adapted to be used in agriculture, for instance on a vineyard at which plants shall be cut. In this case, it may be desirable to have a tool which is fixedly attached to the hand of a user without the danger that the shear drops off the hand. For this purpose, the grip according to an exemplary embodiment of the invention may be adjusted to anatomical dimensions and/or shapes of the hand carrying the shear and can be securely fixed in this position.

The handle and/or the at least one fixing element may be adapted to firmly engage at least one of the group consisting of one or more fingers, a hand, an arm, a foot and a leg of a human user. It is emphasized that applications of the invention as claimed are not restricted to fixing a hand or a part of a hand of a user. In contrast to this, the arrangement of handle and fixing element(s) may in principle be used to be fixed to any desired part of the body. In this context, it should be noted that the term “handle” is not restricted to a component which is to be fixed at a hand, but which may be capable of engaging any part of the human body.

According to another exemplary embodiment of the invention, the handle and the at least one fixing element may be firmly connected to each other. This may allow for a stable arrangement of the different components of the grip.

The at least one fixing element and the angled handle may be adapted in such a manner that a distance between the angled handle and the at least one fixing element may be adjustable in steps or steplessly. According to one configuration, a continuous movement between different distances may be enabled which may allow for an accurate definition of the distance between the angled handle and the fixing element. Alternatively, different adjustment modes may be predefined by the geometrical arrangement of handle and fixation element so that an adjustment is possible in different steps which steps may be adapted to different modes or views of the grip/tool arrangement.

Furthermore, a drawing element/pulling element may be provided at the grip preventing the at least one fixing element from being released from the handle. Such a drawing or pulling element (denoted with reference numeral 4a in FIG. 1b) may be capable to increase the stability of the system.

The handle and the at least one fixing element may be made of a deformable material and may be firmly connected to each other. By providing these components from a flexible material, the grip may conform itself to the geometrical requirements of a user's anatomy. Further, such a deformable material may be realized as some kind of cushioned or padded part protecting a respective part of the body of the user from injury.

The at least one fixing element may be adapted as a protection for an object firmly engaged between the handle and the at least one fixing element. For example, the fixing element may be realized as some kind of shield protecting a part of the body of a human user from injury when the grip/tool combination is used under harsh conditions, for instance in agriculture. By simultaneously using the fixing element as a protection element, it may be dispensable that a user uses additional protection means, like gloves. This may improve the sensitivity of a user and thus the quality of the work performed by the user. Simultaneously, a user may be securely protected from hits, cuts, or the like.

The handle and the at least one fixing element may have different diameters. By allowing different geometrical properties of handle and fixing element, their geometry may be accurately adapted to their desired respective functionality.

The grip may further be manufactured from one or more materials covered by deformable material. Thus, a stable and rigid interior material can be coated by a soft or padded surface portion to increase stability and convenience in use.

The at least one fixing element may be connected with a bottom part of the angled handle by means of one or more recesses provided in the bottom part of the angled handle. The provision of one or more recesses in a bottom part of the angled handle is easy in manufacture and allows to accurately define different distances between angled handle and fixing element.

Furthermore, the grip may comprise an elongated hole in the angled handle and may comprise a pin connected to the at least one fixing element, wherein the pin extends through the elongated hole to allow guiding the at least one fixing element with respect to the angled handle by moving the pin along the elongated hole. Fixing the angled handle with the fixing element using a pin through a hole may allow to simply manufacture the grip and may allow to securely prevent that the two components are undesirably released from one another.

The at least one fixing element and the angled handle may be adapted in such a manner that a distance between the angled handle and the at least one fixing element is adjustable steplessly by means of operating an adjusting knob. By means of such an adjusting knob or turning knob, an accurate and convenient adjustment of the dimension may be enabled.

In the following, exemplary embodiments of the tool arrangement will be described. However, these embodiments also apply for the grip.

The tool arrangement may be arranged in such a manner that the tool is a shear or a scissor.

Particularly, the shear may comprise at least one of the group consisting of an operating lever with a stripping-off edge, a fixed pivotal point and a retracting element. Such a tool arrangement may be adapted in such a manner that fingers and/or a part of a hand of a human user is/are fixed between the fixation element(s) and angled handle, while simultaneously allowing a remaining part of fingers of the human hand (for instance a thumb) to operate the shear to cut an object, like a plant.

### BRIEF DESCRIPTION OF THE DRAWINGS

The drawings include illustrations of grips according to exemplary embodiments of the invention which will be described together with exemplary tools.

FIG. 1a illustrates a tool with a grip according to an exemplary embodiment of the invention.

FIG. 1b illustrates details of a fixation means of the tool with a grip of FIG. 1a.

FIG. 2a illustrates a tool with a grip according to an exemplary embodiment of the invention.

FIG. 2b illustrates details of the grip of FIG. 2a.

### DETAILED DESCRIPTION OF EXEMPLARY EMBODIMENTS

The illustration in the drawing is schematically. In different drawings, similar or identical elements are provided with the same reference signs.

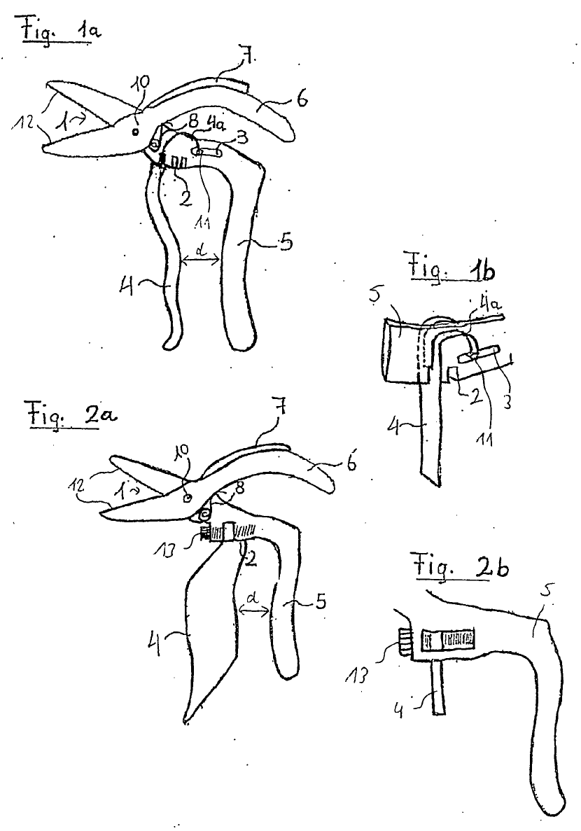

In the following, referring to FIG. 1a, a grip/shear arrangement according to an exemplary embodiment of the invention will be described.

The grip shown in FIG. 1a comprises an angled handle 5, a fixing element 4 and a tool fastening portion allowing to fasten a shear 1 at an end portion of the angled handle 5. In the illustrated configuration, the tool fastened with the grip 4, 5 is the shear 1. However, any other tool may be mounted on the grip of FIG. 1a.

The fixing element 4 is connected with a bottom part of the angled handle 5 in such a manner that a distance “d” between the angled handle 5 and the fixing element 4 is adjustable to allow fingers of a human user (not shown) arranged between the handle 5 and the fixing element 4 to be firmly engaged. At an end portion of the angled handle 5, the shear 1 is fastened.

According to the described embodiment, the shear 1 is fixedly fastened to the angled handle 5. However, alternatively, it may be possible to realize the tool fastening portion at the angled handle 5 in such a manner that different tools may be attached to the grip 4, 5, for instance may be screwed on the grip 4, 5 by a screw/thread combination. Alternatively, a tool may be fastened at the grip with a snap-in connection, in a releasable manner.

In accordance with their shape and their distance regulation feature, the handle 5 and the fixing element 4 are adapted to firmly engage fingers of a user. In the embodiment shown in FIG. 1a and FIG. 1b, the fixing element 4 and the angled handle 5 are adapted in such a manner that the distance “d” between the angled handle 5 and the fixing element 4 is adjustable in steps, namely by fastening the fixing element 4 in one of a plurality of recesses or holes 2 provided in a lower part of the angled handle 5.

As can be taken from FIG. 1b in more detail, a pulling element 4a is provided at an end portion of the fixing element 4 which pulling or drawing element 4a prevents the fixing element 4 from being released from the angled handle 5.

According to the described embodiment, the angled handle 5 and the fixing element 4 are made from a solid material covered by a soft material.

The fixing element 4 is connected with the bottom part of the angled handle 5 by means of the plurality of recesses 2 provided in the bottom part of the angled handle 5. Furthermore, an elongated hole 3 is formed in the angled handle 5. Furthermore, a pin 11 corresponding to the elongated hole 3 is provided and attached to the fixing element 4. The pin 11 extends through the elongated hole 3 to allow to guide the fixing element 4 with respect to the angled handle 5 by shifting the pin 11 along the elongated hole 3.

As can further be taken from FIG. 1a, the shear 1 comprises an operating lever 6 with a stripping-off edge 7, a fixed pivotal point 10 and a retracting element 8, for instance a spring element. The user may fasten four of her or his fingers between elements 4 and 5 and may operate the operating layer 6 with his thumb. Consequently, cutting elements 12 are moved so as to cut an object provided between the cutting elements 12, for instance a plant. The retracting element 8 may drive back the cutting elements 12 into their biased initial position.

FIG. 1a shown the angled grip 5 having recesses (openings) 2 at the lower side. Further, anchorages of fixation means 4 are illustrated with built-up shear 1.

The handle 5 is angled and is connected to the fixation element 4. At this handle 5, different tools 6 may be mounted and are thereby fixed to fingers, hands, arms or legs.

The grip of FIG. 1a comprises the angled handle 5 connected at the lower side with at least one fixing elements 4. The fixing element 4 may serve for adjustably and firmly fixing the grip with the handle 5 with different distances to the grip. The fixing means 4 is arranged at the grip in an undetachable or captive manner. At the grip, various tools may be anchored in a fixed or replaceable manner. However, FIG. 1a shows a tool arrangement in which the shear is fixed at the grip. The handle 5 and the fixing means 4 are firmly connected to each other.

The distance(s) between the fixing element(s) 4 and the handle 5 may be changed in steps. By means of drawing means (see FIG. 1b), an undesired loss of the fixing means 4 may be prevented. Alternatively, the distances between the fixing means 4 and the grip 5 may be varied continuously or steplessly (see FIG. 2b).

The handle 5 and the fixing means 4 have different diameters. The grip 4, 5 is made by different materials are covered with deformable material.

The grip may be adapted for connecting different items which may be connected with each other in a replaceable manner firmly or moveably.

In the following, referring to FIG. 2a, a grip according to an exemplary embodiment of the invention will be described.

FIG. 2a shows an angled grip 5 allowing for continuous/stepless displacement 2 of the fixation means 4 at the lower side. According to the embodiment shown in FIG. 2a, the fixing means 4 is formed as a protection for hand parts or body parts. The fixing element 4 serves as a protection for fingers of a user firmly engaged between the angled handle 5 and the fixing element 4.

FIG. 2b illustrates a continuous/stepless displacement 2 of the fixation means 4.

According to the embodiment shown in FIG. 2b, the distances between the fixing means 4 and the grip 5 may be varied continuously or steplessly.

The fixing element 4 and the angled handle 5 are adapted in such a manner that a distance “d” between the angled handle 5 and the fixing element 4 is adjustable steplessly by means of operating an adjusting knob 13.

It should be noted that the term “comprising” does not exclude other elements or steps and the “a” or “an” does not exclude a plurality. Also elements described in association with different embodiments may be combined.

It should also be noted that reference signs in the claims shall not be construed as limiting the scope of the claims.

1. A grip, comprising
an angled handle;
at least one fixing element;
a tool fastening portion;
wherein the at least one fixing element is connected with a bottom part of the angled handle in such a manner that a distance between the angled handle and the at least one fixing element is adjustable to allow an object arranged between the angled handle and the at least one fixing element to be firmly engaged;
wherein the tool fastening portion is arranged at an end portion of the angled handle and is adapted to fasten at least one tool.

2. The grip according to claim 1,
wherein the tool fastening portion is adapted to fasten at least one tool in a fixed manner or in a replaceable manner.

3. The grip according to claim 1,
wherein the tool fastening portion is adapted to fasten a shear as the at least one tool.

4. The grip according to claim 1,
wherein the angled handle and/or the at least one fixing element is/are adapted to firmly engage at least one of the group consisting of one or more fingers, a hand, an arm, a foot and a leg of a human user.

5. The grip according to claim 1,
wherein the angled handle and the at least one fixing element are firmly connected to each other.

6. The grip according to claim 1,
wherein the at least one fixing element and the angled handle are adapted in such a manner that a distance between the angled handle and the at least one fixing element is adjustable in steps or steplessly.

7. The grip according to claim 1,
comprising a pulling element preventing the at least one fixing element from being released from the angled handle.

8. The grip according to claim 1,
wherein the angled handle and the at least one fixing element are made of a deformable material and are firmly connected to each other.

9. The grip according to claim 1,
wherein the at least one fixing element is adapted to provide a protection for an object firmly engaged between the angled handle and the at least one fixing element.

10. The grip according to claim 1,
wherein the angled handle and the at least one fixing element have different diameters.

11. The grip according to claim 1,
manufactured from one or more materials covered with deformable material.

12. The grip according to claim 1,
wherein the at least one fixing element is connected with a bottom part of the angled handle by means of one or more recesses provided in the bottom part of the angled handle.

13. The grip according to claim 1,
comprising an elongated hole in the angled handle and comprising a pin connected to the at least one fixing element, wherein the pin extends through the elongated hole to allow to guide the at least one fixing element with respect to the angled handle by shifting the pin along the elongated hole.

14. The grip according to claim 1,
wherein the at least one fixing element and the angled handle are adapted in such a manner that a distance between the angled handle and the at least one fixing element is adjustable steplessly by means of operating an adjusting knob.

15. A tool arrangement, comprising
a grip according to claim 1;
a tool;
wherein the tool is fastenable at the tool fastening portion of the grip.

16. The tool arrangement according to claim 15,
wherein the tool is a shear.

17. The tool arrangement according to claim 16,
wherein the shear comprises at least one of the group consisting of an operating lever with a stripping-off edge, a fixed pivotal point, and a retracting element.
